(19) United States
(12) Patent Application Publication
(10) Pub. No.: US 2025/0244216 A1
(43) Pub. Date: Jul. 31, 2025

(54) METHOD FOR EVALUATING A FILLER GEL

(71) Applicant: TEOXANE SA, Genève (CH)

(72) Inventors: Jimmy FAIVRE, Genève (CH); François BOURDON, Genève (CH)

(21) Appl. No.: 19/102,460

(22) PCT Filed: Aug. 10, 2023
(86) PCT No.: PCT/EP2023/072214

§ 371 Date: Feb. 10, 2025

(30) Foreign Application Priority Data
Aug. 10, 2022 (FR) FR2208223

(51) Int. Cl. G01N 3/08

(52) U.S. Cl. CPC G01N 3/08

(57) ABSTRACT

A method for evaluating the mechanical performance of a filler gel, incudes the steps of subjecting a bolus of this gel, present with a predefined initial thickness d₀ between two pressure surfaces, to a predefined compression force F. The development is captured in the variation of the thickness of the gel thus compressed over the course of time. The method includes parameterizing a mathematical model approximating the development observed on the basis of the capture performed, and determining, from the model, a limiting thickness d_{∞} to which the gel tends to develop over the course of time. Information is generated relating to the ability of the gel to maintain its thickness in the tissues, in particular a projection index, by comparing the limiting thickness d_{∞} against the initial thickness d0.

### TECHNICAL FIELD

The present invention relates to filler gels, especially based on polysaccharide, used in the beauty and/or medical field for filling wrinkles and/or giving more relief to certain areas of the face.

### PRIOR ART

Filler gels are, for example, hydrogels based on polysaccharide, in particular on hyaluronic acid (HA), and are injected under the skin using a syringe.

Manufacturers propose filler gels that have various rheological properties depending on the site of gel injection. For example, in the case of an injection into the surface layers of the skin, the gels must lightly fill fine wrinkles and fine lines and be capable of easily following facial movements. On the other hand, gels intended for filling more severe folds and wrinkles and/or for creating volume, referred to as “volumizing” products, must have a capacity to durably maintain their thickness in the layers of the skin, including under the stress of facial movements.

The rheology of the gel and its behavior over time are thus essential elements that need to be controlled if it is sought to obtain filler gels with optimal results.

The rheological measurements of the gels customarily most widely used are those of the moduli G′ and G″, the phase shift angle S being linked to these measurements (tan δ=G″/G′). These measurements are commonly performed under low oscillatory stress with a low amplitude, in their linear viscoelastic region. These measurements do not reflect all the mechanical stress and deformation that a filler gel undergoes in vivo.

These measurements do not make it possible to predict the compression behavior of the gel. However, in the case of a deep implantation, the gel is compressed between tissue layers and its ability to create relief depends on its ability to not overly spread or lose its thickness over time.

In order to characterize the compression behavior of the gel, it is known practice to measure its cohesivity by carrying out a compression test consisting in subjecting a gel bolus to the pressure of a constantly forward-moving plate and in measuring the reaction force of the gel at the end of forward movement.

However, this test does not make it possible to completely reliably predict the behavior of the gel in tissues.

Moreover, there remains an advantage to having tools for characterizing and selecting gels in the laboratory, making it possible to limit the recourse to in vivo tests at the product development stage.

### DISCLOSURE OF THE INVENTION

There is therefore a need to facilitate the evaluation, characterization and development of a new filler gel and in particular to be able to easily distinguish between several gels in order to retain the one or those having the most advantageous properties with regard to the desired result, and in particular for volumizing products, to evaluate in vitro their capacity to maintain their thickness in tissues. In vivo tests are also known, but are lengthy and expensive and require animal sacrifice.

The invention provides a method for directly characterizing the behavior of a gel when it is subjected to a predefined stress in vitro. Such a method makes it possible to measure the capacity of the gel to maintain its initial thickness under a constant fixed normal stress and therefore to take into account the forces applied by the surrounding tissues on a gel in or under the skin, for example associated with facial movements.

For the purposes of the present invention, the term “skin” encompasses the skin of the face, neckline, hands, scalp, abdomen and/or legs, but also the lips.

### SUMMARY OF THE INVENTION

The invention achieves this objective by virtue of a method for evaluating the mechanical performances of a filler gel, comprising the steps consisting in:
1) subjecting a bolus of this gel, present with a predefined initial thickness do between two pressure surfaces, to a predefined compressive force F,
2) capturing the change in the variation of the thickness of the gel thus compressed over time,
3) parameterizing a mathematical model approximating the observed change on the basis of the capture performed,
4) determining, from the model, a limiting thickness d_{∞} toward which the gel tends to change over time,
5) generating information relating to the ability of the gel to maintain its thickness in the tissues, in particular a projection index, by comparing the limiting thickness d_{∞} to the initial thickness do.

By virtue of the invention, information representative of the actual behavior of a gel bolus subjected to a compressive force within the tissues is provided; the higher the capacity to maintain its thickness, the closer the limiting thickness will be to the initial thickness. Compared with a compression test, the method according to the invention is based on a mechanical stress on the gel that is more faithful to what it may be subjected to in vivo.

The method according to the invention has the advantage of being fast and reproducible and of requiring a very small amount of gel to perform the measurement. Indeed, a small amount of gel, for example 1 gram or less, is sufficient to obtain a result with this method, whereas the prior art methods for characterization by compression would require larger amounts thereof.

Hereinafter, the term “deep application” denotes the administration of a gel in the deepest layers of the skin, the hypodermis and the deepest part of the dermis, and/or under the skin (above the periosteum) to “volumize” the soft tissues, such as for filling the deepest wrinkles and/or partially atrophied regions of the contour of the face and/or of the body.

The term “superficial application” denotes the administration, for example by mesotherapy, of a composition superficially in the skin, or on the skin, for the treatment of the superficial layers of the skin, of the epidermis and of the most superficial parts of the dermis, for reducing surface wrinkles and/or for improving the quality of the skin (such as its radiance, its density or its structure) and/or rejuvenating the skin.

The term “median application” refers to the administration of a composition in the median part of the skin for treating the median layers of the skin, and also for reducing median wrinkles. For such intermediate applications, gels having intermediate properties, i.e. properties between properties of gels intended for deep applications and properties of gels intended for superficial applications, are selected. Such gels are sometimes referred to as “utility fillers” or “mid-plane fillers”.

The “degree of modification” (MoD %) of a polysaccharide, such as hyaluronic acid, corresponds to the molar amount of crosslinking agent, such as the amount of crosslinking agent bonded to the polysaccharide, via one or more of its ends, expressed per 100 mol of polysaccharide repeat units. It can be determined by methods known to those skilled in the art, such as nuclear magnetic resonance (NMR) spectroscopy.

The “degree of molar crosslinking” (DC), expressed as %, denotes the mole ratio of the amount of crosslinking agent relative to the amount of polysaccharide repeat units introduced into the crosslinking reaction medium, expressed per 100 mol of polysaccharide repeat units in the crosslinking medium.

According to the invention, the polysaccharide may be any polymer composed of monosaccharides joined together via glycoside bonds. Preferably, the polysaccharide is selected from pectin and pectic substances; chitosan; chitin; cellulose and derivatives thereof, agarose; glycosaminoglycans such as hyaluronic acid, heparosan, dermatan sulfate, keratan sulfate, chondroitin and chondroitin sulfate; and mixtures thereof.

Preferably, the polysaccharide is hyaluronic acid, in particular in salt form, in particular in the form of a physiologically acceptable salt, such as the sodium salt, the potassium salt, the zinc salt, the calcium salt, the magnesium salt or the silver salt, the calcium salt and mixtures thereof. More particularly, the hyaluronic acid is in its acid form or in the form of the sodium salt (NaHA). The filler gel may thus be a gel based on a hyaluronic acid and/or salts thereof.

The phase angle S characterizes the degree of viscoelasticity of a material; it ranges from 0° for a 100% elastic material (all the deformation energy is restored by the material, meaning that the gel is capable of returning to its initial shape after the application of a given deformation) to 90° for a 100% viscous material (all the deformation energy is lost by the material, meaning that it flows and completely loses its initial shape when it is subjected to a deformation).

The “projecting” nature or the ability to “project” of a gel is defined by the retaining of its thickness over time, including under a stress.

The predefined force is preferably constant but may also vary cyclically over time around a mean value. The predefined force may vary cyclically over time around 10%, preferably 5%, more preferably 2%, relative to the mean value. Said force F may be applied between a fixed plate and a movable plate which is moved toward the fixed plate, this movable plate preferably applying a fixed force F.

The abovementioned mathematical model may be selected from the Maxwell, Kelvin, Kelvin-Voigt and Burgers models.

The mathematical model is preferably the generalized Maxwell model for viscoelastic materials, which expresses the gel thickness as a function of time in the form:

$${d}_{gel} ( t ) = {d}_{∞} + \sum Ai \cdot {e}^{( - t / {τ}_{i} )}$$

where d_{∞} is the limiting thickness obtained at equilibrium (after an infinite time for a force within the linear region of the gel) or after a sufficiently long predefined duration (for a force outside the linear region), Aᵢ is a constant, τᵢ is a relaxation parameter, the number of members i of the equation being preferably greater than 1 and less than or equal to 3; in particular, good results have already being obtained for a value of i of 2 in the above expression, that is to say for a model expressed in the form:

$${d}_{gel} ( t ) = {d}_{∞} + {A}_{1} \cdot {e}^{( - t / {τ}_{1} )} + {A}_{2} \cdot {e}^{( - t / {τ}_{2} )}$$

A parameter referred to as the projection index P_{idx}, expressed in %, can be defined by the ratio

$${d}_{∞} / {d}_{0} * 100.$$

The step of generating the item of information relating to the capacity of the gel to retain its thickness may comprise calculating the projection index P_{Idx}.

The initial thickness do may be selected between 100 and 3000 microns, preferably between 200 and 2000 microns, preferably between 500 and 1000 microns, preferably between 600 and 900 microns, better still between 600 and 800 microns, being for example equal to 700 microns.

The force F may be selected between 0.1 and 10 N, preferably between 1 and 5 N, preferably between 1 and 3 N, better still between 1.5 and 2.5 N, being for example equal to 2 N. Such a force value is particularly well suited to filler gels known as volumizing filler gels and/or for deep application.

The invention advantageously makes it possible to mimic various implantation conditions and therefore to predict the behavior of a gel in various implantation configurations by varying the applied force. In this sense, for example, for a volumizing gel, it is possible to increase the compressive force F in order to represent an injection into an area in the dermis and/or under the dermis which may result in higher pressures.

According to the invention, when the gels are intended for deep application, a force F of between 0.1 and 10 N, preferably between 1 and 5 N, more preferably between 2 and 4 N will preferably be selected.

According to the invention, when the gels are intended for superficial application, a force F of between 0.1 and 5 N, preferably between 0.5 and 2 N, more preferably between 0.5 and 1 N, will preferably be selected.

According to the invention, when the gels are intended for a median application, a force F of between 0.1 and 10 N, preferably between 1 and 4 N, more preferably between 1 and 2 N, will preferably be selected.

Thus, during the implementation of the method, at least two evaluations can be carried out at different respective forces F depending on the intended application for the gels, in particular either at a force F of between 1 and 5 N, preferably between 2 and 4 N, or at a force F of between 0.5 and 2 N, preferably between 0.5 and 1 N, or at a force of between 1 and 4 N, preferably between 1 and 2 N.

The amount of gel may be selected between 0.1 and 10 g, preferably between 0.5 and 5 g, more preferably between 0.5 and 2 g, better still between 0.75 and 1 g, being for example equal to 1 g.

In vivo, the surrounding tissues relax, the skin layers stretch, and the normal force due to the skin layers then decreases over time. This avoids complete flow/flattening of the gel. All the gels end up by reaching equilibrium.

With the in vitro method according to the invention, the gel is preferably not flanked on all sides and can therefore in the end flow out of the rheometer, depending on the geometry of the measuring cell of the rheometer. The force application time is selected so as to take into account this flow and is preferably less than 10 h.

Thus, the duration of the abovementioned capture is preferably greater than or equal to 5 minutes, better still greater than or equal to 30 minutes, better still greater than or equal to 1 hour, especially between 30 minutes and 10 hours, especially between 30 minutes and 2 hours, for example 60 minutes.

The method may comprise the step consisting in determining whether compression takes place in the linear viscoelastic deformation region (LVER) of the gel. Advantageously, this step consists of a compression-mode oscillatory strain sweep measurement at a given oscillation frequency in order to determine the linear viscoelastic region and to surround the applied normal force. This measurement is applied over a given deformation range. Preferably, the deformation range covers from 0.1% to 10%, at 1 Hz at 25° C.

The method may comprise the emission of a piece of warning information when the force F is not in the linear viscoelastic deformation region and/or E′<E″, E′ denoting the elastic modulus and E″ denoting the loss modulus.

The elastic modulus E′, also known as storage modulus, corresponds to the energy restored by the gel after having been subjected to compression. This measurement is expressed in Pa. The loss modulus E″ corresponds to the energy dissipated by the gel after having subjected to compression. This measurement is expressed in Pa.

The method may be carried out using a test bench comprising an automated device having a processor programmed to control the force F and to measure the distance over time between the contact surfaces, and also to parameterize the model, calculate the limiting thickness d_{∞} and deliver the information relating to the capacity of the gel to retain its thickness, in particular the projection index P_{Idx}.

The projection index thus calculated may be printed or displayed on an information medium, in particular a notice, packaging of the gel, an information or advertising panel, a commercial or medical brochure, a television screen, a desktop computer screen or a mobile telephone screen, or on a screen of an automated device, for example the automated device of a rheometer.

A further subject of the invention is a method for selecting a filler gel, wherein the method for evaluating according to the invention is implemented for a set of gels to be tested, and the gel is selected according to at least the result of the evaluation, in particular the calculated projection index.

The gels according to the invention may be used for a deep application or for a superficial application, as mentioned above.

Among a set of gels, the gels that have the gel(s) with the highest projection index or indices may be selected. For example, it is possible to select the gels of which the projection indices are greater than or equal to 60%, or even 70%, 75% or 85% or more.

The projection index value can be used to distinguish between gels of which the cohesivities would be similar, for example gels for which the cohesivity measurements differ by less than 10% (relative to the lowest measurement), or even less, for example 8% or less, 5% or less or 2% or less, or even 1% or less.

A further subject of the invention is a method for classifying a set of filler gels according to their mechanical performance, wherein the method for evaluating according to the invention as defined above is implemented for each of these gels, and the gels are classified according to the projection index values obtained.

A further subject of the invention is a method for manufacturing a filler gel, wherein a candidate gel is manufactured in a small amount, and its projection index is then evaluated by implementing the abovementioned method for evaluating according to the invention, and the gel is manufactured in an amount greater than that of the candidate gel, for example at least if the projection index exceeds a predefined threshold.

This method may comprise reformulating the gel and comparing the projection index of the gel after reformulation with that before reformulation.

The reformulation may comprise modification of the polysaccharide concentration and/or of the amount of crosslinking agent bonded to the polysaccharide of the gel.

The method may comprise the step consisting in automatically determining, by iterations, parameters of the method for manufacturing the filler gel, such as the values of polysaccharide concentration and of amount of crosslinking agent, making it possible to obtain the best performance, given the dependency of the projection index on these parameters of the method for manufacturing the filler gel.

A further subject of the invention is a method for manufacturing a filler gel, wherein several candidate gels are manufactured in a small amount, and then their projection index is evaluated by implementing the abovementioned method for evaluating according to the invention, a gel is selected on the basis of the evaluation results, and the selected gel is manufactured in an amount greater than that of the candidate gel.

A further subject of the invention is a method for supervised learning of a neural network, wherein the concentration values for the polysaccharide, in particular for hyaluronic acid, of the gel, the degree of modification MoD %, the degree of molar crosslinking DC, G′, G″, the phase angle δ and the width of the linear viscoelastic region LVER and also the value of the limiting thickness d_{∞} for tested gels are provided as input, and the network is trained to deliver as output the value of the limiting thickness d_{∞} according to said input parameters.

### BRIEF DESCRIPTION OF THE DRAWINGS

The invention will possibly be better understood on reading the following detailed description of non-limiting examples of implementation thereof, and on examining the appended drawing, in which:

FIG. 1 is a block diagram of an example of the method according to the invention,

FIG. 2 illustrates the step of applying a constant fixed force to the gel sample,

FIG. 3 illustrates the change over time of the values of the thickness of the gel over the course of the measurement for five examples of gels,

FIG. 4 represents the projection index as determined by the implementation of the invention for several different filler gels, and

FIG. 5 represents, in bar diagram form, the results of measurements of cohesivity and of projection index for several filler gels.

### DETAILED DESCRIPTION

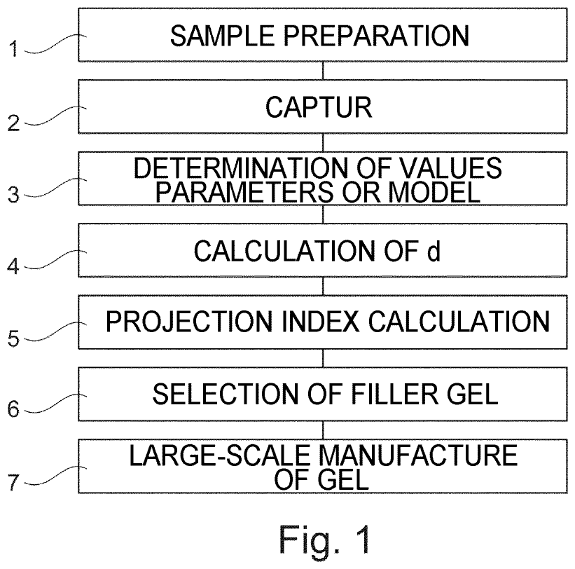

The method according to the invention may comprise, as illustrated in FIG. 1, a step 1 of preparing the sample to be tested.

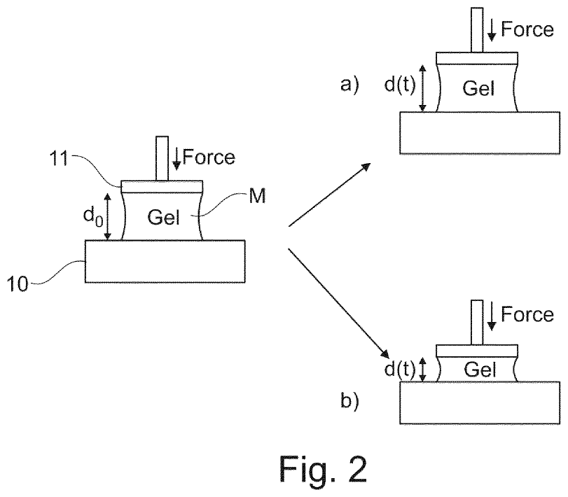

Particularly, as illustrated in FIG. 2, a bolus of a mass M of the filler gel is for example deposited on a base plate 10, then a pressure plate 11, which is parallel and horizontal to it is lowered into contact with said base plate. During this step 1, this pressure plate applies a constant force on the sample, until the thickness of the material, given by the distance between the plates 10 and 20, is equal to a predefined value do, for example equal to 700 microns.

Once the thickness reaches this predefined value do, and the gel resistance force is less than or equal to the value of the force F to be applied, the capture can be commenced while taking this instant as the origin of the capture times. The continuation of the change in the thickness as a function of time can then be measured during step 2, the pressure applied by the pressure plate remaining for example fixed and constant.

Depending on the behavior of the gel, the thickness thereof may barely change at all over the course of the measurement, as illustrated under a) in FIG. 2, or may change more markedly, as illustrated under b).

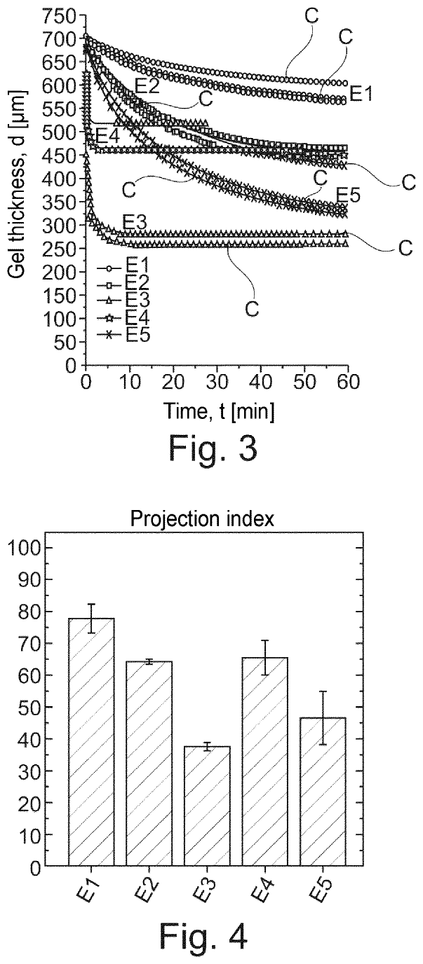

FIG. 3 represents the result of the measurements for five different filler gels based on hyaluronic acid, denoted E1 to E5.

Once the capture has ended, the method comprises a step 3 during which the values to be given to the parameters of a mathematical model are sought so as to have the best adjustment of the model with the change in the thickness observed.

In the example under consideration, the model used is the generalized Maxwell model, which gives the change in the thickness of the gel as a function of time t using the formula:

$${d}_{gel} ( t ) = {d}_{∞} + \sum Ai \cdot {e}^{( - t / {τ}_{i} )}$$

Good results are n as soon as the following two exponential terms are present:

$${d}_{gel} ( t ) = {d}_{∞} + {A}_{1} \cdot {e}^{( - t / {τ}_{1} )} + {A}_{2} \cdot {e}^{( - t / {τ}_{2} )}$$

To find the values of the parameters d_{∞}, Ai and τᵢ which make it possible to obtain the best adjustment, use may be made of any software suitable for determining the values of these parameters by iteration, for example the Origin Pro® software.

In this simulation, d_{∞} corresponds to the thickness at equilibrium after an infinite time, in the scenario in which the applied force F is in the linear deformation region.

In order to carry out the compression and the capture of a gel bolus, preferably equal to 1 g, use is made, for example, of a DHR2 rheometer (TA Instruments®) with a pressure plate 40 mm wide made of anodized aluminum, with a parallel-plate geometry, at a temperature of 25° C.

In FIG. 3, the curves C obtained after adjusting the parameters of the model have been plotted. It may be seen that quite a precise approximation of thee change in the thickness is obtained using the model, for example with a regression R² of greater than 0.99.

Once the parameters have been adjusted, a value of the limiting thickness d_{∞} is obtained in step 4, and can be used in step 5 to calculate the projection index P_{Idx}=d_{∞}/d₀*100 The mathematical model is best suited to gels for which the test is carried out in the linear viscoelastic region LVER, but the invention also provides useful information by being applied to gels tested outside their linear viscoelastic region.

In the latter case (outside LVER), for the simulation and calculation of d_{∞}, consideration is given to a time which is not infinite but is long enough, for example greater than 1 hour, preferably greater than 5 hours, preferably greater than 10 hours, more preferably greater than 30 hours, even more preferably greater than 72 hours. Advantageously, consideration will be given to a time of less than 7 days, preferably less than 5 days, more preferably less than 4 days.

The method may comprise a step of verifying that the filler gel is correctly tested in its linear viscoelastic region LVER.

To do this, the values E′ and E″ may be determined by subjecting them to dynamic mechanical analysis, with an oscillating mechanical compressive stress that changes in amplitude, for example 0.1% to 10%, 1 Hz at 25° C.

Before putting in place step 1, it is then in particular possible to verify that the force F applied in the evaluation method is included in the LVER range of the gel to be evaluated and that the modulus E′ is greater than the module E″. For the purposes of the present invention, the linear region LVER is considered to be the deformation range extending from an initial value of the elastic modulus E′ up to the value of the elastic modulus E′ decreased by 10% of its initial value.

It is thus verified that, among the gels E1 to E5, the gels E3 and E4 are not stressed in their linear region for an applied stress of 2 N. That corresponds to a rapid collapse in FIG. 3.

Comparisons of the projection indices of the various filler gels may be carried out, as illustrated in FIG. 4, in order to draw therefrom information useful for selecting the best gels for a given application.

For example, the gel E1 has a projection index of 78%, that is to say that it is capable of maintaining 78% of its initial thickness after an infinite time under the stress of 2 N, while the gel E5 is capable of maintaining 47% of its initial thickness.

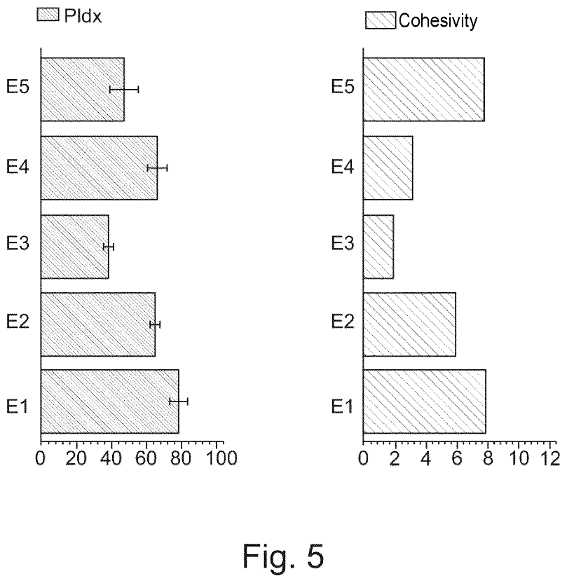

In FIG. 5, the projection index values, obtained with the invention, of commercial “volumizing” hyaluronic acid-based gels are compared with the cohesivity values, obtained with the constant-speed compression test of the prior art, of these same gels.

The legend of the commercial hyaluronic acid-based gels tested in FIGS. 3, 4 and 5 is as follows: E1: RHA 4 (Teoxane), E2: Restylane Volyme (QMED), E3: Restylane Lyft (QMED), E4: Juverderm Voluma (Allergan), E5: Boletero Volume (Merz).

The projection index values exemplified are measured at 25° C. using a DHR2 rheometer equipped with a parallel flat plates geometry (diameter 40 mm, anodized aluminum, TA Instruments®) combined with the TRIOS software (TA Instruments®). 1 gram of gel is applied between the plates and the gap between these plates corresponds to an initial thickness (dᵢₙᵢₜᵢₐₗ) of 700 μm. A compressive force of 2 Newtons is applied for 1 hour and the change in variation of the thickness of the gel is captured. The parameter dₘ is calculated using the OriginPro® software by determining it via the generalized Maxwell model

$${d}_{gel} ( t ) = {d}_{∞} + \sum Ai \cdot {e}^{( - t / {τ}_{i} )}$$

where d_{∞} is the limiting thickness obtained at equilibrium (after an infinite time for a force within the linear region of the gel) or after a sufficiently long predefined duration (for a force outside the linear region), Aᵢ is a constant, τᵢ is a relaxation parameter, and the number of members i of the equation is equal to 2.

The projection index values are subsequently calculated as follows:

$${P}_{Idx} ( \% ) = \frac{{d}_{∞}}{{d}_{initial}} \cdot 100$$

The cohesivity is measured at a temperature of 25° C. using a DHR2 rheometer equipped with a parallel flat plate geometry (diameter 40 mm, anodized aluminum, TA Instruments®) combined with the TRIOS software (TA Instruments®). 2 grams of gel are deposited at the center of the Peltier plate. The initial gap between the plates is set at 2.60 mm and is then compressed at a constant speed of 100 μm/s. The mechanical compression strength of the gel was measured at the end of the compression cycle, when the gap reaches 1.82 mm (70% of the initial gap).

The gel E5 has a better cohesivity value than the gel E2 (9 N vs 7 N) and has a lower projection index than E2 (47% compared to 64%), and will thus be less suitable in its ability to durably maintain its thickness in the layers of the skin and to retain its thickness, including under the stress of facial movements.

The invention thus makes it possible to predict the behavior of the gel in situ more reliably and accurately than the simple measurement of cohesivity.

For the gels tested in their linear region LVER, P_{Idx} is a direct measurement of their capacity to maintain their initial thickness under a given compressive stress. For those tested beyond their linear region LVER, P_{Idx} gives an indication as to their ability to retain their thickness over a certain period; in theory, in a non-confined geometry, these gels would continue to flow, but in reality, the surrounding tissues provide a certain containment that blocks gel creep and thus P_{Idx} remains information of interest for predicting the behavior of the gel in vivo.

It is possible to implement the method according to the invention to calculate the projection index P_{Idx} for several candidate gels, and to select the one or those having the highest P_{Idx} value for deep applications, for example.

It is also possible to use the P_{Idx} measurement as an aid in the formulating of a new gel, by adjusting certain manufacturing parameters such as the degree of molar crosslinking DC or the amount of polysaccharide, in particular of hyaluronic acid, depending on the impact of the modification of these manufacturing parameters on the value of P_{Idx} in order to iteratively arrive at the best result.

It is thus possible to classify the gels according to the P_{Idx} value obtained for each of them, or even to carry out several evaluations at different respective forces, corresponding to different intended applications, for example superficial, median and/or deep injection, and perform gel rankings for each of these applications. The gels are, for example, classified in ascending or descending order.

It is possible to manufacture several candidate gels in a small amount, then to evaluate their projection index in vitro by implementing the evaluation method described above, and to select a gel on the basis of the results of the evaluation; the selected gel can then be manufactured in a larger amount, in order to be used commercially.

It is possible to use the results of measurements of the parameter d_{∞} to supply a neural network with a view to having a tool for predicting the value of d_{∞} for various input parameters, and thus to dispense with the in vitro measurement once a sufficient number of data points have been collected.

It is thus possible to carry out the supervised learning of a neural network, wherein, during the learning, the polysaccharide concentration values, in particular hyaluronic acid concentration values, the degree of modification MoD %, the molar degree of crosslinking DC, G′, G″, the phase angle δ (tan δ=G″/G′), the width of the linear viscoelastic region LVER, and also the value of the limiting thickness d_{∞} are for example provided as input for tested gels.

Once the network has been trained, the same input parameters are provided, namely the polysaccharide concentration values, in particular the hyaluronic acid concentration values, the degree of modification MoD %, the degree of molar crosslinking DC, G′, G″, the phase angle δ (tan δ=G″/G′) and the width of the linear viscoelastic region LVER, and the network delivers as output a prediction of the value of the limiting thickness d_{∞}.

The expression “between” should be understood as being limits included, unless otherwise mentioned.

1. A method for evaluating the mechanical performances of a filler gel, comprising the steps of:
1) subjecting a bolus of this gel, present with a predefined initial thickness do between two pressure surfaces, to a predefined compressive force F,
2) capturing the change in the variation of the thickness of the gel thus compressed over time,
3) parameterizing a mathematical model approximating the observed change on the basis of the capture performed,
4) determining, from the model, a limiting thickness d_{∞} toward which the gel tends to change over time,
5) generating information relating to the ability of the gel to maintain its thickness in the tissues by comparing the limiting thickness d_{∞} to the initial thickness d₀.

2. The method as claimed in claim 1, wherein the force F is constant or varies cyclically over time around a mean value.

3. The method as claimed in claim 2, wherein the force F is constant.

4. The method as claimed in claim 1, wherein the mathematical model is selected from the Maxwell, Kelvin, Kelvin-Voigt, and Burgers models.

5. The method as claimed in claim 4, wherein the mathematical model is the generalized Maxwell model for viscoelastic materials, which expresses the gel thickness as a function of time in the form:
$${d}_{gel} ( t ) = {d}_{∞} + \sum Ai \cdot {e}^{( - t / {τ}_{i} )}$$
where d_{∞} is the thickness at equilibrium, Aᵢ is a constant, and τᵢ is a relaxation parameter.

6. The method as claimed in claim 5, wherein the mathematical model is expressed in the form:
$${d}_{gel} ( t ) = {d}_{∞} + {A}_{1} \cdot {e}^{( - t / {τ}_{1} )} + {A}_{2} \cdot {e}^{( - t / {τ}_{2} )}$$

7. The method as claimed in claim 1, wherein a parameter, referred to as the projection index P_{Idx}, expressed in %, defined by the following ratio is calculated
$${d}_{∞} / {d}_{0} * 100.$$

8. The method as claimed in claim 1, wherein the initial small thickness do is selected between 500 and 1000 microns.

9. The method as claimed in claim 1, wherein the force F is selected between 0.1 and 10 N.

10. The method as claimed in claim 1, wherein at least two evaluations are carried out at different respective forces F depending on the intended application for the gels, in particular either at a force F of between 1 and 5 N.

11. The method as claimed in claim 1, wherein the amount of gel is selected between 0.1 and 10 g, better still between 0.5 and 5 g, even better still 0.5 and 2 g, being in particular equal to 1 g.

12. The method as claimed in claim 1, comprising the step of determining whether compression takes place in the linear viscoelastic deformation region (LVER) of the gel.

13. The method as claimed in claim 12, wherein the step includes determining whether the compression takes place in the linear viscoelastic deformation region of the gel is performed by subjecting the gel to a compressive oscillatory stress sweep.

14. The method as claimed in 13, comprising the emission of a piece of warning information when the force F is not in the linear viscoelastic deformation region and/or E′<E″, E′ denoting the elastic modulus and E″ denoting the loss modulus.

15. A method for classifying a set of filler gels according to their mechanical performance, wherein the method for evaluating as claimed in claim 1, is implemented for each of these gels, and the gels are classified according to the result of the measurements.

16. The method as claimed in claim 1, which is carried out using a test bench comprising an automated device having a processor programmed to control the force F and to measure the distance over time between the contact surfaces, and also to parameterize the model, calculate the limiting thickness, and deliver the information relating to the capacity of the gel to retain its thickness.

17. The method as claimed in claim 1, wherein said information is a projection index and is printed or displayed on an information medium.

18. The method as claimed in claim 1, wherein the filler gel is a gel based on a hyaluronic acid and/or salts thereof.

19. The method as claimed in claim 1, wherein the force F is applied between a fixed plate and a movable plate which is moved toward the fixed plate, F.

20. A method for selecting a filler gel, wherein the method for evaluating as claimed claim 1, for a set of filler gels to be tested is carried out, and the gel is selected according to at least the results of the evaluation.

21. The method as claimed in claim 20, wherein a projection index value is used to discriminate gels of which the results in the compression test are similar.

22. A method for manufacturing a filler gel, wherein a candidate gel is manufactured in a small amount, and its projection index is then evaluated by implementing the method for evaluating as claimed in claim 1, and the gel is manufactured in an amount greater than that of the candidate gel, at least if the projection index exceeds a predefined threshold.

23. A method for manufacturing a filler gel, wherein several candidate gels are manufactured in a small amount, and then their projection index is evaluated by implementing the method for evaluating as claimed in claim 1, a gel is selected on the basis of the evaluation results, and the selected gel is manufactured in an amount greater than that of the candidate gel.

24. A method for supervised learning of a neural network, wherein the polysaccharide concentration values, the degree of modification MoD %, the degree of molar crosslinking DC, G′, G″, the phase angle δ (tan δ=G″/G′), the width of the linear viscoelastic region LVER and also the value of the limiting thickness d_{∞} for gels tested by implementing the method for evaluating as claimed in claim 1, are provided as input, and the network is trained to deliver as output the value of the limiting thickness d_{∞.}
